(19) United States
(12) Patent Application Publication
(10) Pub. No.: US 2026/0233348 A1
(43) Pub. Date: Aug. 13, 2026

(54) MACHINE FOR THE LASER WORKING OF TUBES AND PROFILES, IN PARTICULAR MACHINE FOR THE LASER CUTTING OF TUBES AND PROFILES, WITH AN IMPROVED UNLOADING SYSTEM FOR UNLOADING THE TUBE OR PROFILE AT THE END OF THE WORKING PROCESS

(71) Applicant: ADIGE-SYS S.P.A., Levico Terme TN (IT)

(72) Inventors: Matteo BALDESSARI, Pergine Valsugana TN (IT); Marco BEBER, Novaledo TN (IT); Paolo ARMELLINI, Borgo Valsugana TN (IT)

(21) Appl. No.: 19/150,594

(22) PCT Filed: Dec. 18, 2023
(86) PCT No.: PCT/IB2023/062869

§ 371 Date: Jul. 24, 2025

(30) Foreign Application Priority Data
Jan. 27, 2023 (IT) 102023000001233

(51) Int. Cl. B23K 37/04; B23K 26/00; B23K 101/06

(52) U.S. Cl. CPC B23K 37/0426; B23K 26/00; B23K 2101/06

(57) ABSTRACT

A machine for laser working of tubes and profiles includes an unloading system for unloading the tube or profile at the end of a working process, the unloading system including one or more supporting and unloading devices arranged along a feed axis of the machine and below the axis. Each supporting and unloading device includes a table and a driving unit. The table includes a first table portion having a flat upper surface, and a second table portion extending laterally outwards relative to the first table portion and having a flat upper surface inclined to the upper surface of the first table portion. The driving unit is configured to produce a roto-translational movement of the table, with a vertical translation and a rotation about a horizontal axis of rotation, oriented parallel to the feed axis of the machine, between a working position and an unloading position.

### TECHNICAL FIELD OF THE INVENTION

The present invention relates to a machine for the laser working of tubes and profiles, in particular a machine for the laser cutting of tubes and profiles, provided with an unloading system for unloading the tube or profile at the end of the working process.

### STATE OF THE ART

Unloading systems for machines for the laser working of tubes and profiles, in particular for the laser cutting of tubes and profiles, with the function of unloading each time the tube or profile from the machine once the planned working process has been completed, are known.

For example, EP2492041 discloses an unloading system comprising one or more unloading carriages and one or more support carriages, wherein both the unloading carriage(s) and the support carriage(s) are movable along a forward longitudinal direction of the tube. Each unloading carriage comprises an unloading platform which is hinged to a support structure about an axis of rotation, oriented parallel to the aforementioned longitudinal direction, and is connected to the rod of a hydraulic cylinder. The unloading platform of each unloading carriage is thus movable under control of the hydraulic cylinder between a horizontal position, in which the tube can be unloaded on the upper face of the unloading platform without rolling or sliding, and an inclined position, in which the tube can roll or slide by gravity into a container arranged next to the machine or, alternatively, on a conveyor device arranged next to the machine.

However, such an unloading system is not able to control in an optimal way the unloading movement of the tube from the unloading platform of each unloading carriage towards the container or the conveyor device, particularly in case of tubes and profiles with a non-circular cross-section. Furthermore, in case of large tubes (in terms of length and/or in terms of cross-sectional area), such an unloading system is not able to completely avoid the risk that the tube may, during unloading, collide with other parts of the machine, damaging them.

In case of machines intended to work with tubes and profiles of great length, in particular a length of more than 8 metres, and/or with tubes and profiles having a cross-section of great size, in particular with a diameter of more than 300 mm, it is known to use unloading systems comprising, as schematically shown in FIGS. 1 to 3 of the attached drawings, a vertically movable support plate P, which is arranged under the tube T being worked to support the tube during working and deposit it, at the end of the working process, by vertical downward movement, on a pair of transport chains C provided on opposite sides with respect to the support plate P. During the working process, as shown in FIG. 1, the support plate P supports the head portion of the tube T, while the remaining part of the tube is supported by one or more mandrels M. Once the working process has been completed, the worked portion of tube T, still supported by the support plate P, is placed on the transport chains C by virtue of the downward vertical movement of the support plate, as shown in FIGS. 2 and 3, to be finally transported by the transport chains C out of the working area of the machine. Such an unloading system is used, for example, in the machines LT14 and LT24 manufactured by the Applicant.

Although this known unloading system has proven to be particularly effective, robust and reliable, there is still a need for an unloading system that is less expensive and allows to unload the tube in less time. Furthermore, there is a need for an unloading system that can be easily reconfigured to work with tubes of different sizes.

### SUMMARY OF THE INVENTION

It is an object of the present invention to provide a machine for the laser working of tubes and profiles with an unloading system for unloading the tube or profile at the end of the working process, which is not affected by the drawbacks of the prior art mentioned above.

This and other objects are fully achieved according to the present invention by virtue of a machine for the laser working of tubes and profiles provided with an unloading system as defined in independent claim 1.

Advantageous embodiments of the invention are specified in the dependent claims, the subject-matter of which is to be understood as forming part of the following description. In summary, the invention is based on the idea of providing an unloading system comprising one or more supporting and unloading devices arranged one after the other along the feed axis of the machine (i.e., along the longitudinal axis of the tube or profile being worked) and below said axis, wherein each supporting and unloading device comprises a table and a driving unit associated with the table, wherein said table comprises a first table portion having an upper surface and a second table portion which extends laterally outwards relative to the first table portion and has an upper surface, and wherein said driving unit is configured to produce a roto-translational movement of the table of each supporting and unloading device, with a vertical translation and a rotation about a horizontal axis of rotation, oriented parallel to the feed axis of the machine, between a working position, in which the upper surface of the first table portion is oriented so as to support the tube or profile being worked and in which the upper surface of the second table portion is oriented so that an outer longitudinal edge of said upper surface is positioned at a height greater than that of an inner longitudinal edge of said upper surface, and an unloading position, in which the table is vertically displaced and rotated about said axis of rotation with respect to said working position, in such a manner that an outer longitudinal edge of the upper surface of said first table portion is positioned at a height lower than that of an inner longitudinal edge of said upper surface, and the outer longitudinal edge of the upper surface of the second table portion is positioned at a height greater than or equal to that of an inner longitudinal edge of said upper surface.

Due to the configuration of the table and the configuration of the driving means associated therewith, the supporting and unloading devices forming part of the unloading system according to the invention are able to effectively move the tube or profile towards the unloading area next to the machine, even in case of tubes or profiles with a non-circular cross-section.

### BRIEF DESCRIPTION OF THE DRAWINGS

Further features and advantages of the present invention will be evident from the following detailed description, given purely by way of non-limiting example with reference to the accompanying drawings, in which:

FIGS. 1 to 3 schematically illustrate the operation of a known unloading system for machines for the laser working of tubes, wherein each figure shows both a side view and a top view of the machine with its unloading system;

FIGS. 4 and 5 are perspective views, from two different view angles, of the unloading system of a machine for the laser cutting of tubes and profiles according to an embodiment of the present invention, with the unloading system in the condition of working on a tube;

FIG. 6 is a perspective view similar to FIG. 5, but with the unloading system in the condition of unloading of a tube (not shown);

FIGS. 7 and 8 are a perspective view and a side view, respectively, showing only the supporting and unloading devices of the unloading system according to FIGS. 4 and 5, in the tube working condition;

FIGS. 9 and 10 are front views showing a divider member of the unloading system according to FIGS. 4 and 5 in the condition wherein the divider member is lowered and in the condition wherein the divider member is raised, respectively;

FIG. 11 is a perspective view of a supporting and unloading device of the unloading system of FIGS. 4 and 5;

FIGS. 12 and 13 are a side view and a front view of the supporting and unloading device of FIG. 11;

FIG. 14 is a perspective view showing in detail the driving unit associated with the table of the supporting and unloading device of FIG. 11;

FIGS. 15 to 18 are front views showing the supporting and unloading device of FIG. 11 in four different positions from a normal working position to an unloading position;

FIGS. 19 to 25 are front views showing in sequence a series of positions taken by the table of one of the supporting and unloading devices and by one of the divider members of the unloading system of FIGS. 4 and 5, when the machine is used with a tube having a circular cross-section; and

FIGS. 26 to 35 are front views showing in sequence a series of positions taken by the table of one of the supporting and unloading devices and by one of the divider members of the unloading system of FIGS. 4 and 5, when the machine is used with a tube having a square cross-section.

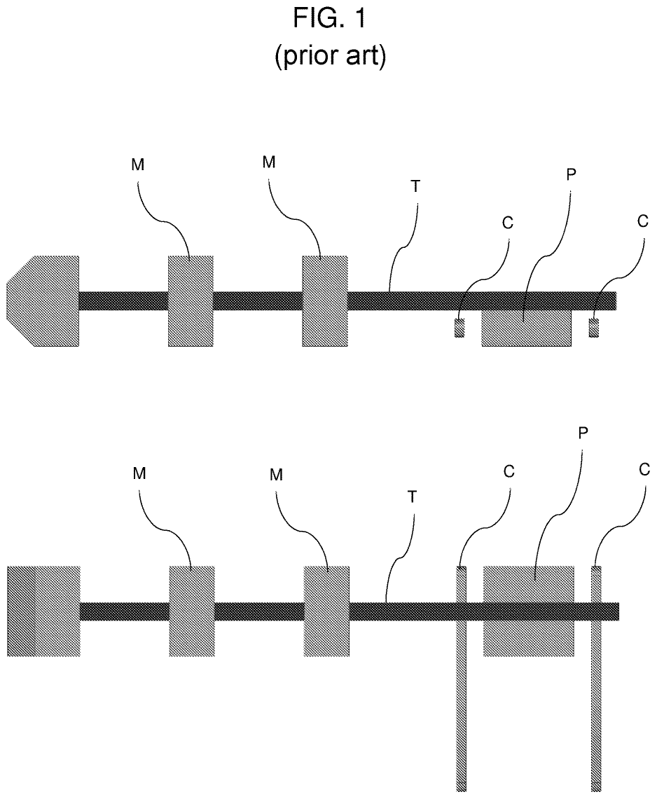

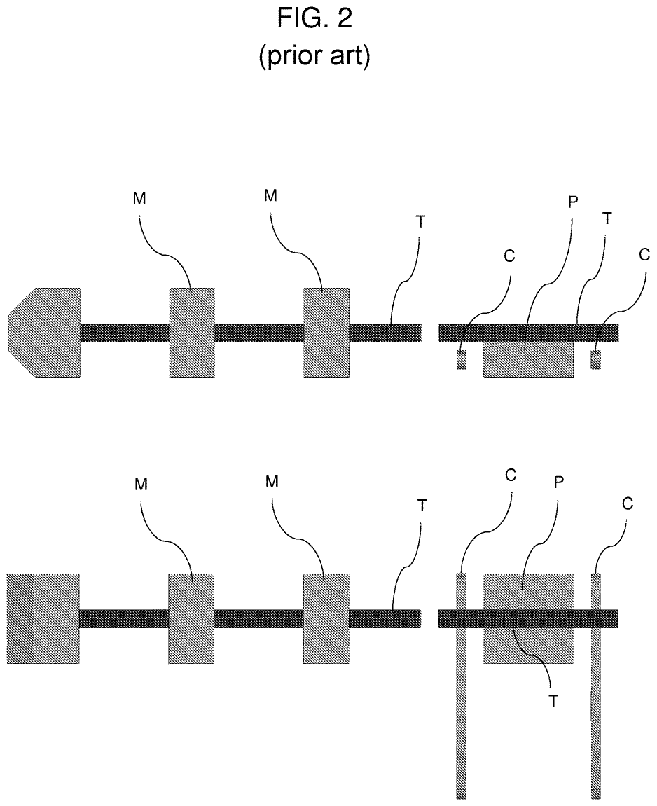

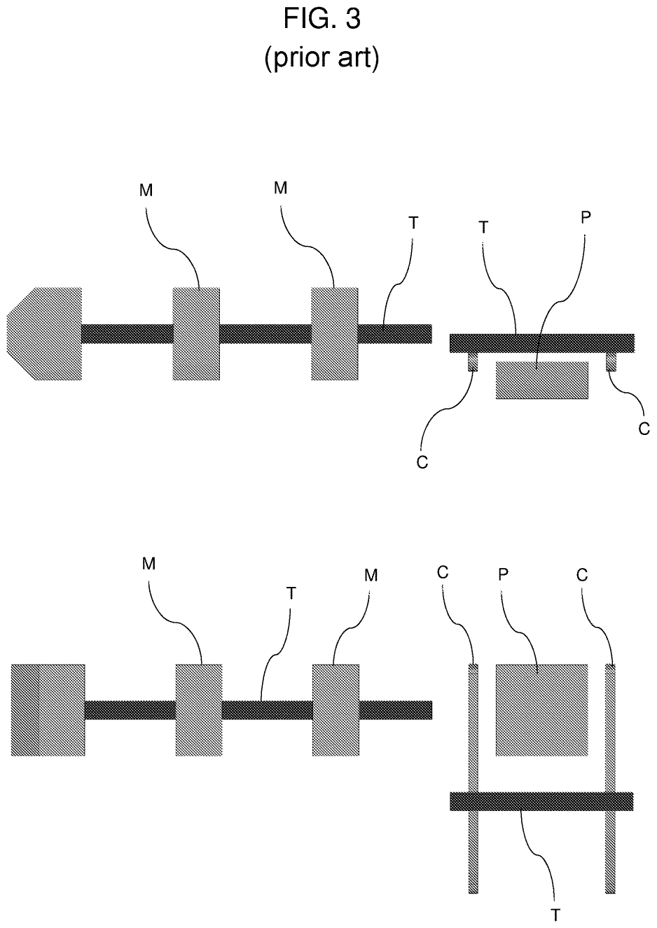

### DETAILED DESCRIPTION

In the following description and claims, the term “longitudinal” is used to identify a direction coincident with, or parallel to, a longitudinal axis of the tube or profile being worked on the machine, while the term “transverse” is used to identify a direction lying in a plane perpendicular to the longitudinal axis. Furthermore, terms such as “upper” and “lower”, or “horizontal” and “vertical” etc., used in relation to the unloading system, are intended to refer to the condition in which the unloading system is installed on the machine.

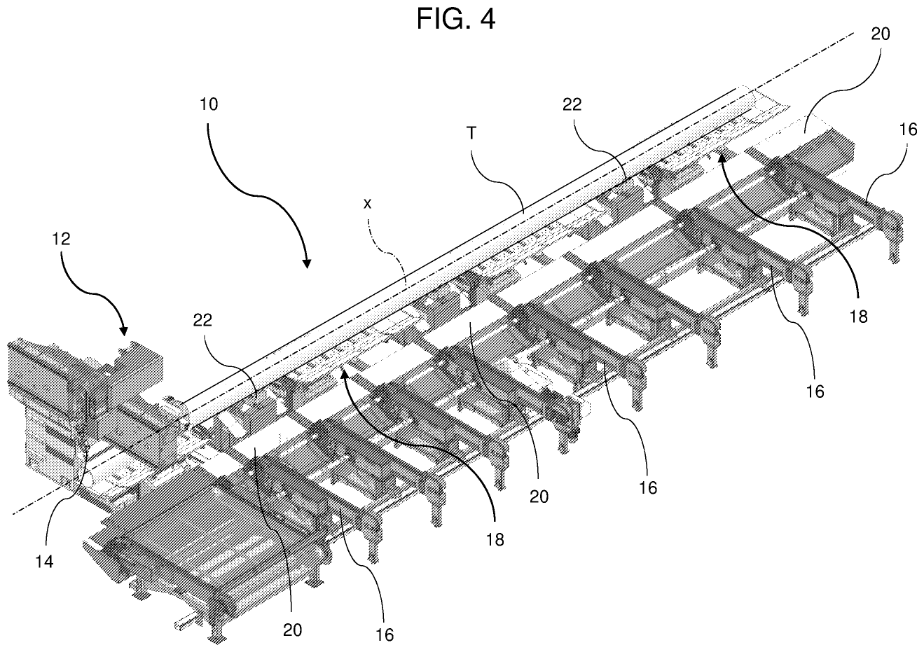

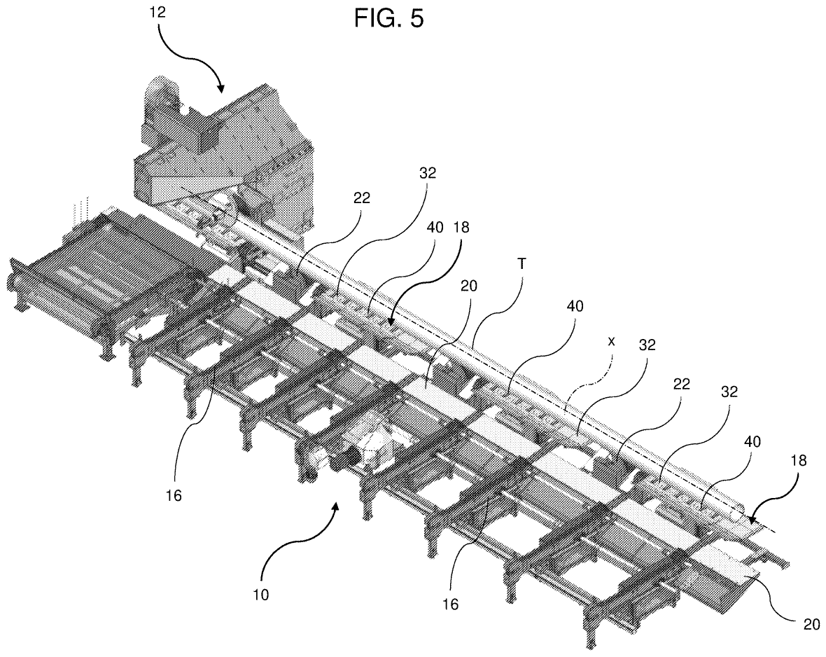

With reference first to FIGS. 4 and 5, a machine for the working of tubes and profiles, to which an unloading system according to the invention is applicable, is generally indicated with 10. In the example proposed herein, the machine is a machine for the laser cutting of tubes and profiles, but the invention is equally applicable to other types of machines for the laser working of tubes and profiles.

The machine 10 comprises, in a per-se-known manner, a working unit 12 with a working head 14 capable of performing working operations, which in the present case are cutting operations, but might also include other types of operations, such as welding or additive manufacturing operations, by means of a laser beam focused on a tube T. The tube T shown in FIGS. 4 and 5 is a tube with a circular cross-section, but nevertheless the machine 10 is capable of working on tubes with a cross-section of any other shape, for example (though not exclusively) square or rectangular, as well as on profiles of any shape, for example C-profiles, T-profiles, IPE profiles, HEA profiles, and the like. For the sake of convenience, only the term tube will be used in the following description, it being understood, however, that what is illustrated below is equally applicable to the case the machine is used to work on a profile.

The machine 10 further comprises a tube-holding carriage (not shown, but anyway of a per-se-known type) provided with holding means configured to hold the tube T at an end thereof (tail end). Such holding means define a feed axis x of the machine, with which the longitudinal axis of the tube T is aligned during working. Upstream of the working head 14, and next to it, there is also advantageously provided a support and guide mandrel (not shown, but anyway of a per-se-known type) capable of supporting and guiding the tube T being worked while keeping the longitudinal axis of the tube T aligned with the feed axis x. During working, the tube T is caused by the tube-holding carriage to move forward along the feed axis x, as well as possibly to rotate about this axis.

The machine 10 further includes an unloading system for unloading the tube T at the end of the working process. More precisely, the unloading system has the function of bringing the tube T from the working position in which the tube T is arranged during the working process, that is—as mentioned above—a position in which the longitudinal axis of the tube T is aligned with the feed axis x of the machine, to an unloading position, in which the tube T is displaced laterally with respect to the working position. In particular, in the example illustrated herein, in the unloading position the tube T is arranged on conveyor means, such as conveyor belts 16, arranged alongside the machine 10 and configured to move the tube T laterally, while keeping it substantially parallel to the feed axis x of the machine, until the tube T is brought to a storage area (not shown) where it can be, for example, picked up by appropriate handling means (also not shown, but anyway of a per-se-known type).

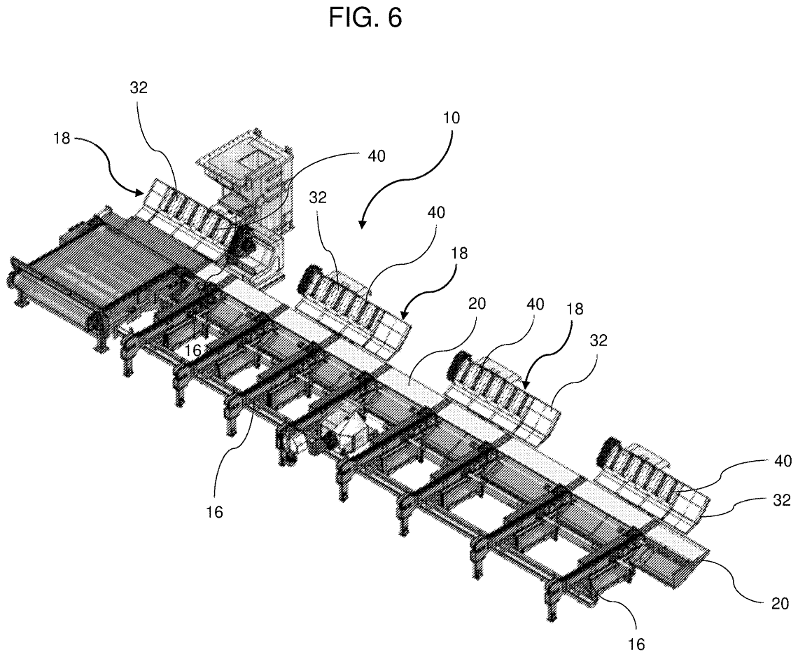

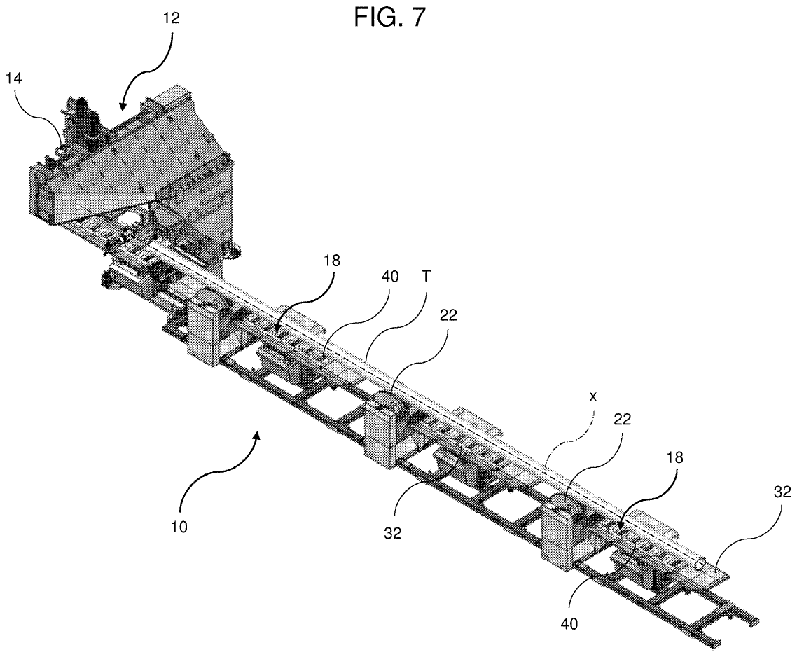

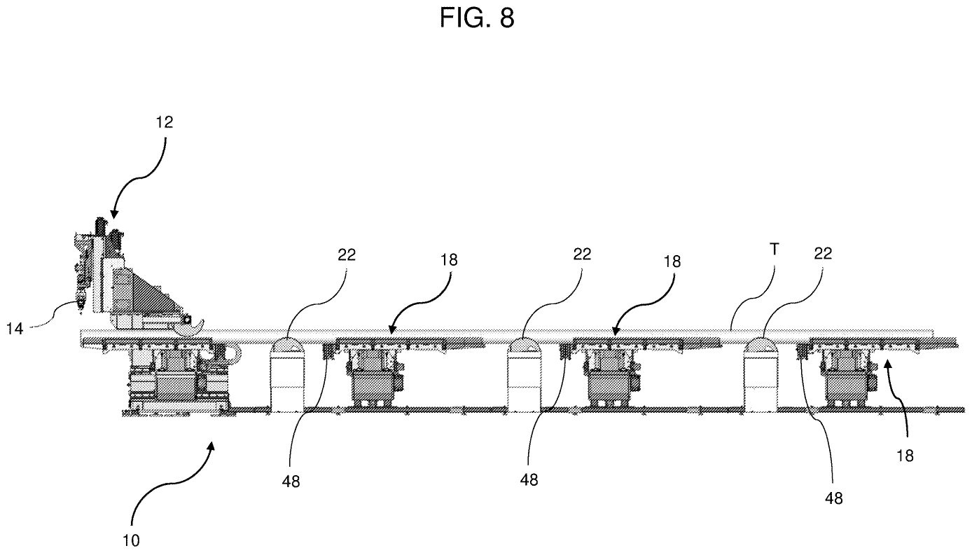

The unloading system basically comprises a plurality of supporting and unloading devices 18 (or, more generally, one or more supporting and unloading devices 18), arranged one after the other along the feed axis x of the machine and below said axis, and a plurality of divider members 20 arranged laterally to the supporting and unloading devices 18, in particular between these latter and the conveyor belts 16. The supporting and unloading devices 18 perform the function of supporting the tube T during the working process, together with any other support devices, such as, for example, rotating support members 22 (as can be more clearly observed in FIGS. 7 and 8), while once the working process has been completed they perform the function of moving the tube T from the working position, depositing it on the divider members 20. In turn, the divider members 20 perform the function of protection devices during the working process, ensuring a high level of safety for the operator, by separating laterally the working area, in which the tube T being worked is placed, from the external environment, while once the working process has been completed they perform the function of depositing on the conveyor means the tube T received from the supporting and unloading devices 18, as will be explained in detail below. In this respect, FIGS. 4 and 5, as well as FIGS. 7 and 8, show the supporting and unloading devices 18 in the working position, in which they support the tube T during the working process, with the tube T arranged with its longitudinal axis aligned with the feed axis x of the machine, while FIG. 6 shows the supporting and unloading devices 18 in the unloading position, in which they allow the tube T to be displaced by gravity onto the divider members 20. As far as the divider members 20 are concerned, they are shown in FIGS. 4 to 6 only in the lowered position, in which they are ready to receive the tube T from the supporting and unloading devices 18.

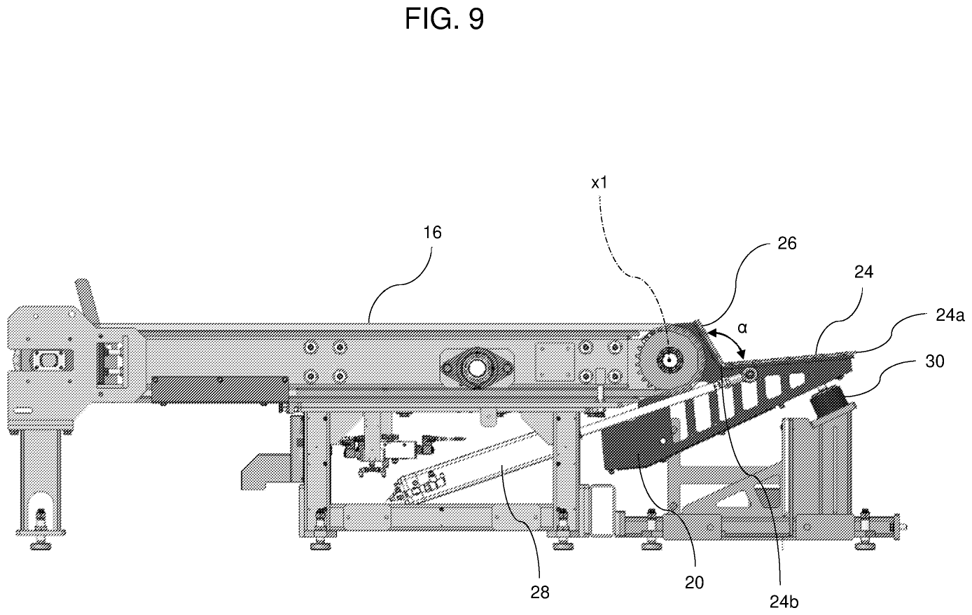

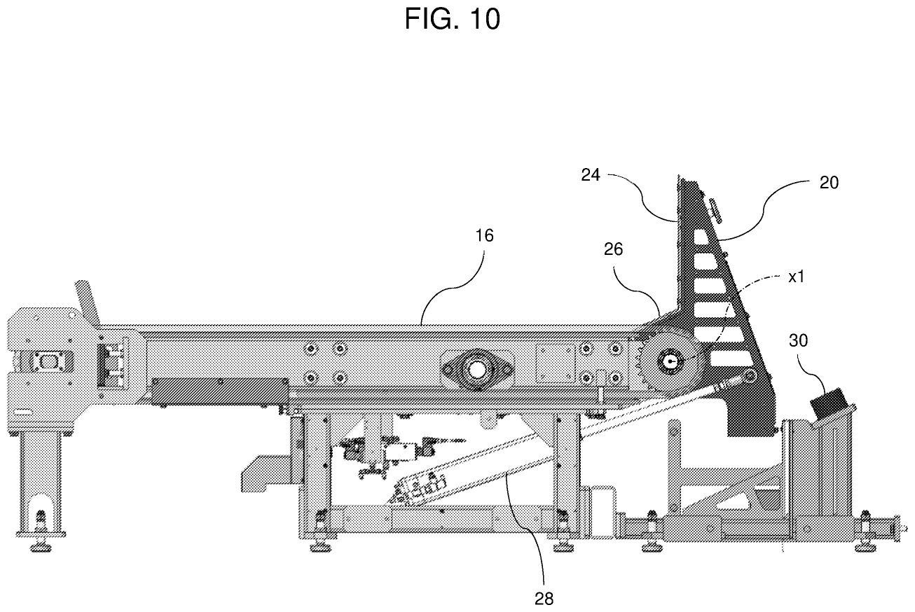

With reference now to FIGS. 9 and 10, each divider member 20 forms an operating surface which, in the embodiment proposed herein, comprises a first surface portion 24, substantially flat, and a second surface portion 26, also substantially flat, which is arranged adjacent to the first surface portion 24 and forms with the latter an angle α greater than 90°, in particular between 95° and 125°, for example equal to 115°. More generally, however, the operating surface might have a shape different from the one proposed herein, for example being formed by two flat surfaces suitably joined to each other or by a single surface suitably shaped.

Each divider member 20 is movable between the aforementioned lowered position (FIG. 9) and a raised position (FIG. 10). According to the embodiment proposed herein, the movement of the divider member 20 between the lowered position and the raised position takes place by rotation about a horizontal axis of rotation x1, in particular an axis of rotation oriented parallel to the feed axis x of the machine, under control of actuator means comprising for example one or more pneumatic cylinders 28.

In the lowered position of the divider member 20, which is, for example, advantageously defined by limit switch members 30 (only one of which can be seen in FIGS. 9 and 10), the operating surface faces the supporting and unloading devices 18 in order to receive the tube T from them once the working process has been completed. In particular, in this position the first surface portion 24 is slightly inclined to the horizontal, for example by an angle of between 5° and 15°, so that a proximal longitudinal edge 24a (i.e. a longitudinal edge facing the feed axis x of the machine) of said surface portion is at a height greater than that of a distal longitudinal edge 24b (i.e. a longitudinal edge facing the opposite side with respect to the feed axis x of the machine) of said surface portion. In this way, once the tube T has been deposited by the supporting and unloading devices 18 on the first surface portion 24 of each divider member 20, it can slide or roll along said surface portion towards the second surface portion 26, until it stops against this latter.

In the raised position of the divider member 20, the first surface portion 24 extends substantially vertically and faces the conveyor belt(s) 16, i.e. the opposite side with respect to the feed axis x of the machine.

With the movement of the divider members 20 from the lowered position to the raised position, the tube T resting on the support surfaces of the divider members 20 is then transferred onto the conveyor belts 16 to be transported by these letters to the aforementioned storage area. At this point, the divider members 20 remain in the raised position until the end of the processing of another tube T, thereby acting, thanks to the substantially vertical arrangement of the first surface portion 24, as protection elements that separate laterally the working area of the machine, in which the tube T being worked is placed, from the external environment. As already mentioned, this system ensures a high degree of safety for the operator, since it allows to protect the operator both from laser radiation (emitted by the working head of the machine or reflected by the tube being worked or other surfaces of the machine) and from the projection of particulate and processing Residues.

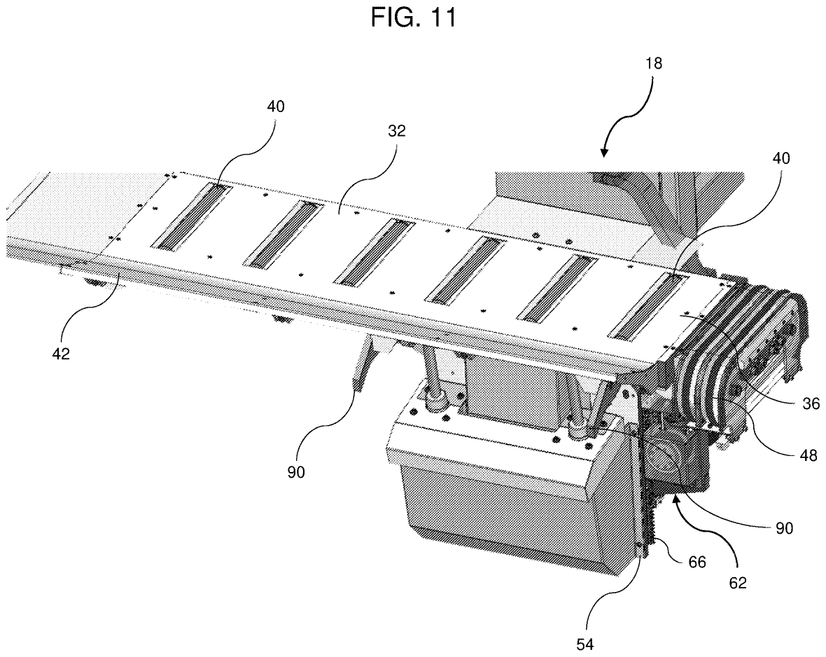

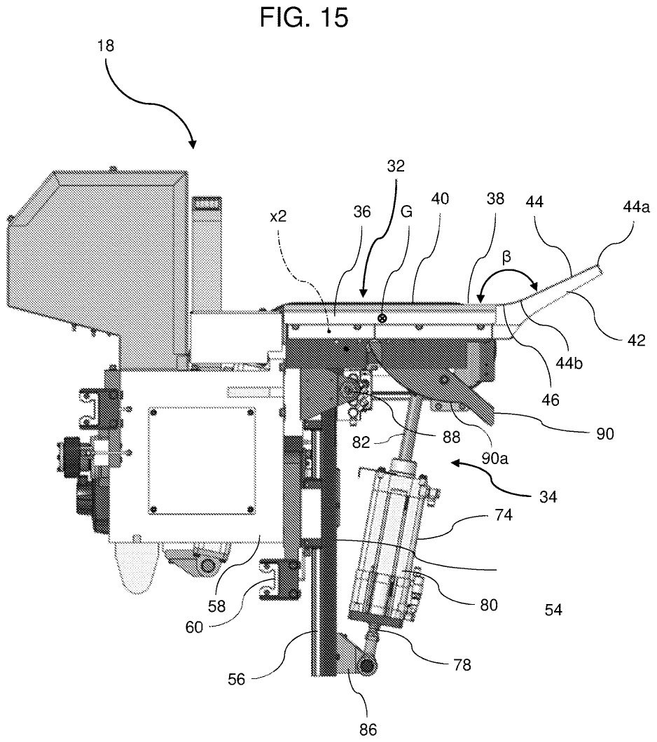

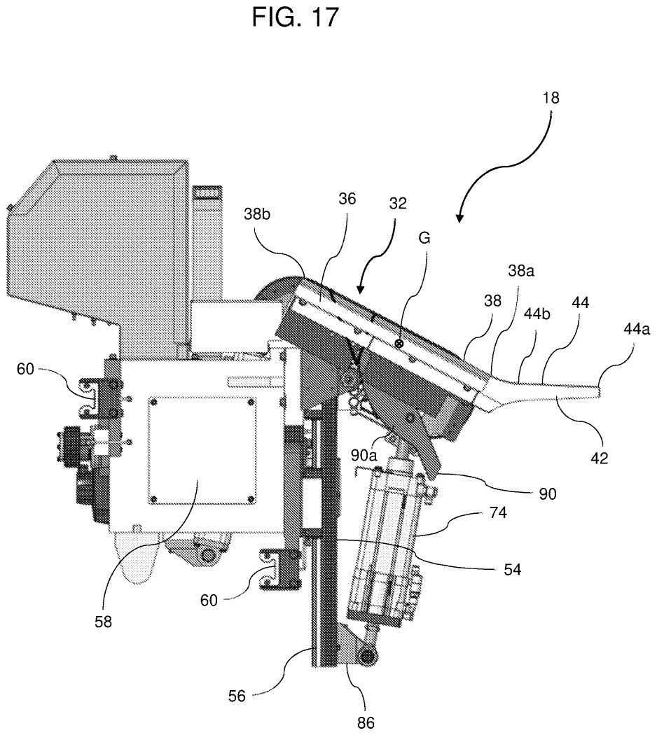

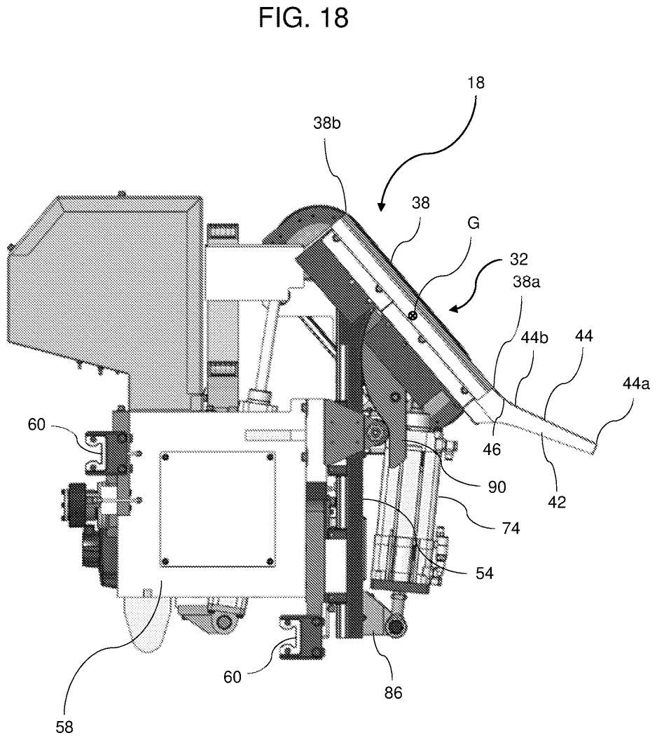

With reference now to FIGS. 11 to 18, each supporting and unloading device 18 basically comprises a table 32 and a driving unit 34 associated with the table 32 to produce a roto-translational movement of the table 32 in the transverse plane (i.e. in the plane perpendicular to the feed axis x of the machine) between a working position (FIG. 15) and an unloading position (FIG. 17 or FIG. 18). The unloading position of FIG. 17 and the unloading position of FIG. 18 are two of the possible unloading positions that can be obtained, since the unloading system is able to suitably define the unloading position depending on the type of tube T being worked.

The table 32 comprises first of all a first table portion 36 having an upper surface 38, which in the embodiment proposed herein is a substantially flat surface, but which might also be a slightly arcuate surface, in particular with concavity facing upwards. A plurality of idle rollers 40 (which can be seen better in FIGS. 5 to 7) are mounted on the upper surface 38 of the first table portion 36, longitudinally spaced apart from each other, and are rotatably supported for rotation about respective axes of rotation oriented parallel to the plane of the upper surface 38 and perpendicular to the feed axis x of the machine. As shown for example in FIG. 7, in the working position of the table 32 the idle rollers 40 act as support elements for the tube T during the working process. The table 32 further comprises a second table portion 42 extending laterally outwards relative to the first table portion 36 and having an upper surface 44. In the example proposed herein, also the upper surface 44 of the second table portion 42, like the upper surface 38 of the first table portion 36, is a substantially flat surface. However, the upper surface 44 might be a non-flat surface, for example it might be a slightly arcuate surface, in particular with concavity facing upwards. The upper surface 44 of the second table portion 42 is inclined by an angle β to the upper surface 38 of the first table portion 36, in particular an angle greater than 135°, preferably an angle greater than 150°, so that when the upper surface 38 is oriented horizontally, an outer longitudinal edge 44a of the upper surface 44 is at a height greater than that of an inner longitudinal edge 44b of said surface, as shown in FIG. 15. The upper surface 38 of the first table portion 36 and the upper surface 44 of the second table portion 42 are preferably joined to each other by an arcuate joining surface 46, particularly in the case where both the upper surface 38 and the upper surface 44 are substantially flat surfaces. According to a further embodiment (not shown in the drawings), the table 32 comprises a third table portion which extends laterally inwards relative to the first table portion 36, thus on the opposite side with respect to the second table portion 42, and has an upper surface having, for example, although not necessarily, a shape similar to that of the upper surface 44 of the second table portion 42.

More generally, therefore, the table 32 has a cradle-like shape, with a main portion formed by the first table portion 36 and with one or two lateral portions, formed by the second table portion 42 and, where present, by the third table portion, which extend laterally, like banks, from the opposite longitudinal edges of the first table portion 36.

Preferably, in the embodiment proposed herein (as can be better seen in FIGS. 11 to 14), the first table portion 36 of the table 32 is provided at one of its longitudinal ends with at least one roller chain 48 (in the present case a pair of roller chains arranged side by side) wound on a pair of sprockets 50 and 52. The sprockets 50 and 52 are both mounted in a freely rotatable manner, and thus the roller chain 48 is freely movable in one direction or the other. The roller chains 48 of the tables 32 of the various supporting and unloading devices 18 have the function, while the tube T is being worked, of “accompanying” the possible rotary movements of the tube T about the feed axis x controlled by the holding means of the machine 10 and, during the unloading of the tube T, in particular in the case of a tube with a cross-section of non-circular shape, of facilitating the sliding of the tube T along the first table portion 36, avoiding its slipping on the rollers 40 provided on said table portion. Although in the embodiment proposed herein the roller chains 48 are provided at only one of the two longitudinal ends of each table 32, they might still be provided at both longitudinal ends of each table 32. Furthermore, other devices with a similar function might be provided instead of roller chains.

The driving unit 34, as mentioned above, is configured to move the table 32 between the working position of FIG. 15, in which the upper surface 38 of the first table portion 36 is oriented substantially horizontally and the upper surface 44 of the second table portion 42 is therefore inclined to the horizontal by an angle corresponding to the aforementioned angle β, whereby the outer longitudinal edge 44a of the upper surface 44 of the second table portion 42 is placed at a height greater than that of the inner longitudinal edge 44b of said surface, and the unloading position of FIG. 17 or FIG. 18, in which both the upper surface 38 of the first table portion 36 and the upper surface 44 of the second table portion 42 are inclined to the horizontal, with an outer longitudinal edge 38a of the upper surface 38 of the first table portion 36 placed at a height lower than that of an inner longitudinal edge 38b of said surface and with the outer longitudinal edge 44a of the upper surface 44 of the second table portion 42 placed at a height lower than (or, at most, at the same height as) that of the inner longitudinal edge 44b of said surface.

The table 32 is carried by a first support structure 54 which extends mainly vertically and is supported in a vertically movable manner, by means of linear guides 56 (shown in FIGS. 15 to 18), by a second support structure 58 of the supporting and unloading device 18. More specifically, the table 32 is hinged with its first table portion 36 to an upper end of the first support structure 54 so as to be able to rotate with respect to the latter about a horizontal axis of rotation x2, in particular an axis of rotation oriented parallel to the feed axis x of the machine. Advantageously, the axis of rotation x2 is not aligned with the centre of gravity G of the first table portion 36 but spaced apart from the latter in the direction of the feed axis x of the machine. In this way, a rotation of the table 32 relative to the first support structure 54 about the axis of rotation x2 in a clockwise or counterclockwise direction (with respect to the point of view of a person looking at FIGS. 15 to 18) results in a downward or upward displacement, respectively, of the centre of gravity G of the first table portion 36.

Furthermore, the second support structure 58 of each supporting and unloading device 18 is advantageously mounted in turn on a fixed support structure (not shown in the drawings) so that it can be moved relative to the latter parallel to the feed axis x of the machine. In this respect, slide pads fixed to the second support structure 58 and sliding along respective guide rails (not shown) attached to the fixed support structure are indicated with 60.

The driving unit 34 comprises first of all a first actuating device 62 for controlling the vertical translational movement of the first support structure 54 relative to the second support structure 58.

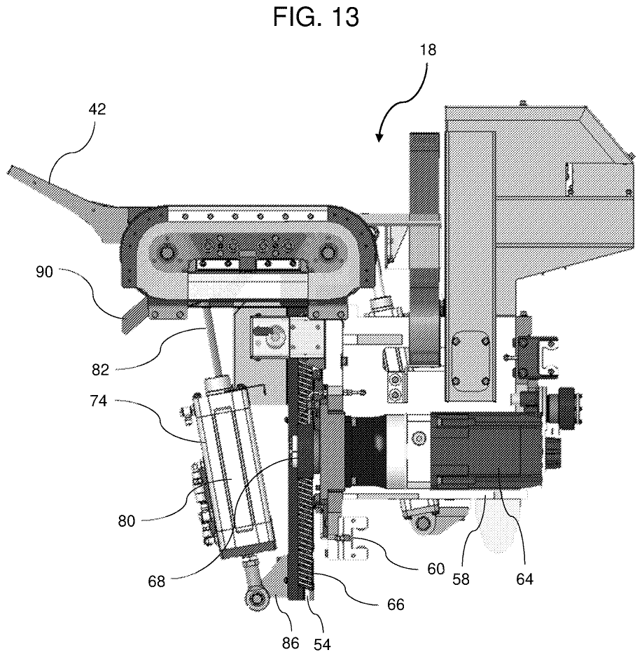

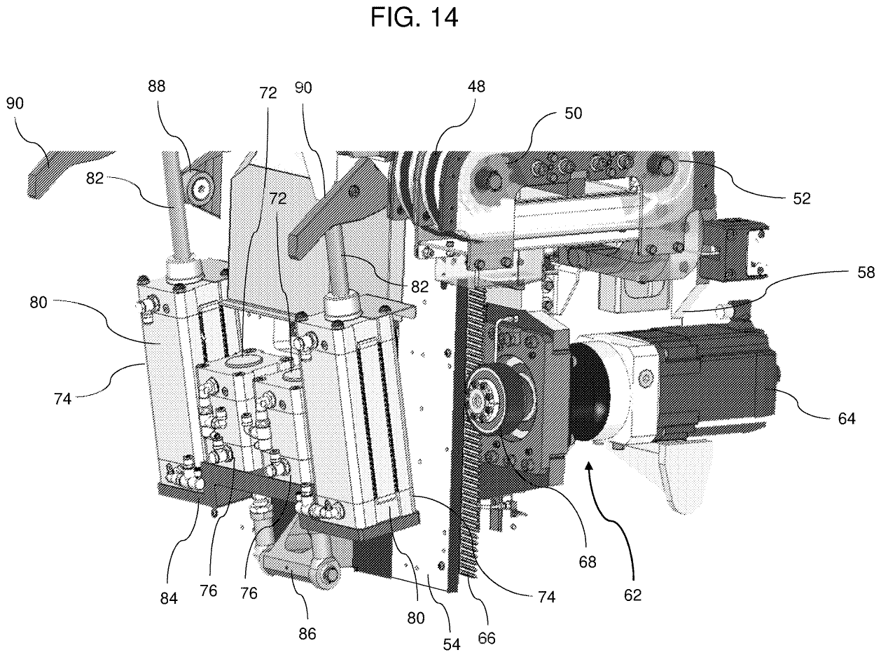

With reference in particular to FIGS. 13 and 14, in the embodiment proposed herein, the first actuating device 62 comprises a motor 64, in particular an electric motor, arranged to generate a rotary movement and a motion conversion mechanism, for example a mechanism comprising a rack 66 and a pinion 68 meshing with the rack 66, arranged to convert the rotary movement generated by the motor 64 into a vertical translational movement. More specifically, in the illustrated example, the motor 64 is carried by the second support structure 58 and the rack 66 is attached to the first support structure 54. In this way, a rotation of the pinion 68 in one direction or the other controlled by the motor 64 results in a vertical upward or downward translation of the first support structure 54, and therefore of the table 32 carried by the latter. This vertical translational movement serves, among other things, during the processing of the tube T, to suitably position the table 32 vertically relative to the feed axis x so as to provide adequate support to the tube T that is being worked.

The driving unit 34 further comprises a second actuating device 70 interposed between the first support structure 54 and the table 32 so as to generate a rotary movement of the table 32 in one direction or the other relative to the first support structure 54 about the axis of rotation x2.

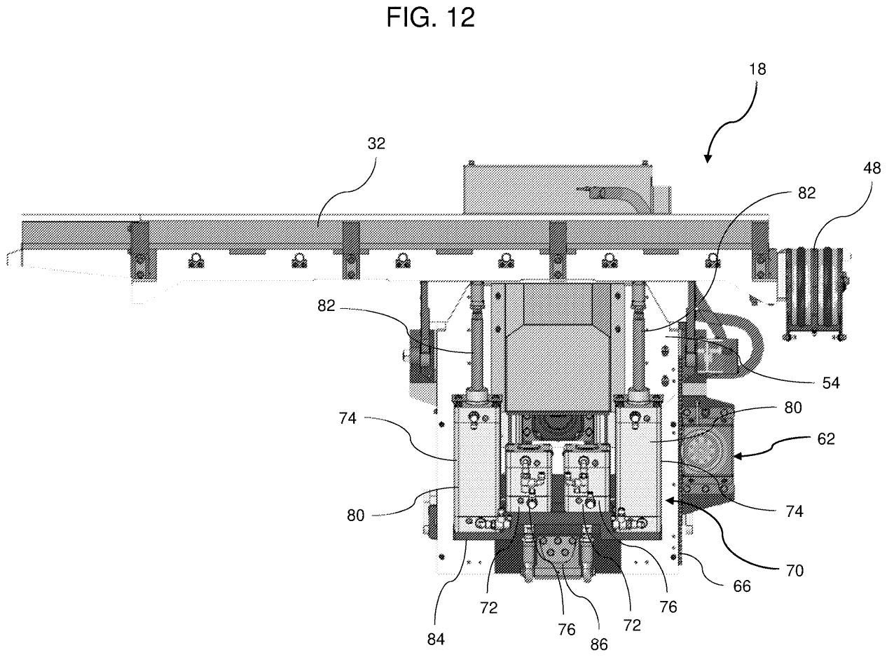

With reference in particular to FIGS. 12 to 14, in the embodiment proposed herein, the second actuating device 70 comprises a first pair of pneumatic cylinders 72, or more generally a first pair of linear actuators, and a second pair of pneumatic cylinders 74, or more generally a second pair of linear actuators, operating in series with respect to the first pair of pneumatic cylinders 72. The pneumatic cylinders 72 each comprise a cylindrical housing 76 and a rod 78 protruding from the cylindrical housing 76, and, likewise, the pneumatic cylinders 74 each comprise a cylindrical housing 80 and a rod 82 protruding from the cylindrical housing 80. Both the cylindrical housings 76 of the pneumatic cylinders 72 and the cylindrical housings 80 of the pneumatic cylinders 74 are fixed to a support base 84, in particular—although not necessarily—with the cylindrical housings 76 of the pneumatic cylinders 72 arranged centrally next to each other and with the cylindrical housings 80 of the pneumatic cylinders 74 arranged laterally on opposite sides of the cylindrical housings 76 of the pneumatic cylinders 72.

The rods 78 of the two pneumatic cylinders 72 are facing downwards and are hinged with their respective free ends to a bracket 86 attached to a lower end of the first support structure 48, while the rods 82 of the pneumatic cylinders 74 are facing upwards and are hinged with their respective free ends to the first table portion 36 of the table 32, in particular to a point of the first table portion 36 located between the centre of gravity G of said table portion and the second table portion 42. A retracting movement of the pneumatic cylinders 72, as well as of the pneumatic cylinders 74, thus produces a rotary movement of the table 32 relative to the first support structure 48 about the axis of rotation x2 in a counterclockwise direction with respect to a person looking at FIG. 13, or in a clockwise direction with respect to a person looking at FIGS. 15 to 18, i.e. in a direction such that the second table portion 42 is moved downwards.

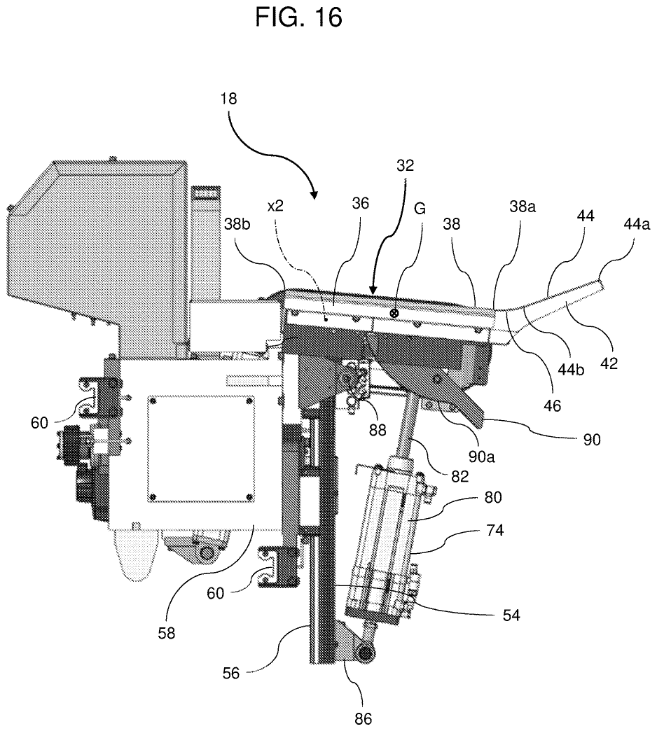

Both the pneumatic cylinders 72 and the pneumatic cylinders 74 are advantageously controlled so as to cause an extension/retraction movement of the respective rod up to the end of its stroke. More specifically, the pneumatic cylinders 72 are configured so that the movement of the respective rods 78 in one direction or the other is such as to cause rotation of the table 32 in one direction or the other about the axis of rotation x2 by a first angle of a small magnitude, for example equal to 5°, as shown in FIG. 16, while the pneumatic cylinders 74 are configured so that the movement of the respective rods 82 in one direction or the other is such as to cause rotation of the table 32 in one direction or the other about the axis of rotation x2 by a second angle greater than the first one, in particular an angle greater than 45°, for example equal to 55°, as shown in FIG. 18.

The driving unit 34 further comprises a cam mechanism with a roller-shaped rolling element 88 carried by the second support structure 52, in particular above the bracket 86, and with a cam element 90 which is fixed to the table 32, in particular to the first table portion 36, and has a working surface 90a suitably shaped to cooperate with the outer cylindrical surface of the rolling element 88. For reasons of force balancing, there are preferably two such cam mechanisms, arranged on longitudinally opposite sides with respect to the second actuating device 70, as shown in FIG. 11, or more generally at least two such cam mechanisms.

In the working position of FIG. 15, both the first pair of pneumatic cylinders 72 and the second pair of pneumatic cylinders 74 are extended, so as to keep a substantially horizontal orientation of the upper surface 38 of the first table portion 36. Starting from said position, first the pneumatic cylinders 72 are retracted, so as to cause rotation (clockwise rotation, with respect to a person looking at FIGS. 15 to 18) of the table 32 relative to the first support structure 48 about the axis of rotation x2 of the aforementioned first angle (for example, equal to 5°), as shown in FIG. 15. The pneumatic cylinders 74 are then retracted, so as to cause a further clockwise rotation (with respect to a person looking at FIGS. 15 to 18) of the table 32 relative to the first support structure 48 about the axis of rotation x2. Such further rotation of the table 32 causes at a certain point, as shown in FIG. 17, the cam element 90 of the cam mechanism carried by the table 32 to come into contact with the rolling element 88 carried by the second support structure 52. In such a condition (which in the example illustrated herein corresponds to a rotation of the table 32 about the axis of rotation x2 by an angle of 25° to the horizontal, but which might, of course, also be a different angle), the pneumatic cylinders 74 are still in traction, since the respective rods 82 have not yet reached the end-of-stroke position of the retraction movement, but a further retraction movement of the respective rods 82 is prevented by the contact between the cam element 90 and the rolling element 88 of the cam mechanism.

At this point, the upward vertical translational movement of the first support structure 54, along with the table 32, is controlled by the first actuating device 62. As a result of this movement, and also as a result of the pulling action exerted by the pneumatic cylinders 74, which keeps the cam element 90 in contact with the rolling element 88 of the cam mechanism, the cam mechanism produces a further rotation of the table 32 relative to the first support structure 48 about the axis of rotation x2 up to the position of FIG. 18. In this last phase of the movement, therefore, the table 32 translates upwards and, at the same time, rotates about the axis of rotation x2 according to a law of motion defined by the profile of the cam element 90 of the cam mechanism. In this case, therefore, the axis of rotation x2 can reach in the unloading position a height greater than the height at which it is located when the table 32 is in the working position.

Depending on the type of tube T being worked, the movements described above with reference to FIGS. 15 to 18 may be combined in different ways. For example, in the case of small tubes, the pneumatic cylinders 72 and 74 might be actuated simultaneously, instead of sequentially, so that the table 32 reaches the unloading position as quickly as possible. In addition, the rotary movement of the table 32 controlled by the cam mechanism might be performed only partially, in case it is not necessary to achieve a great inclination of the table 32 to the horizontal.

Such movements are managed by a control unit of the machine, which is programmed to send suitable control signals to the various actuators of the driving unit 34, namely to the motor 64 of the first actuating device 62 and to the pairs of pneumatic cylinders 72 and 74 (or, more generally, to the pairs of linear actuators) of the second actuating device 70, in such a way that, once a tube T has been worked, the tables 32 of the one or more supporting and unloading devices 18 (depending on the length of the tube) are moved from the working position to the unloading position defined above, and then brought back to the working position in view of the working of another tube.

Such a driving unit offers the advantage of allowing the movement of the table 32 to be controlled according to the desired law of motion, both in terms of vertical translation and in terms of rotation about the axis of rotation x2, by controlled actuation of the first actuating device 62 only, wherein the term “controlled actuation” is to be understood as meaning position-control actuation. In fact, the pneumatic cylinders 72 and 74 of the second actuating device 70 do not require position control, but as mentioned are simply controlled in extension or retraction. As regards the pneumatic cylinders 72, the movement of the rod 78 in one direction or the other is always a movement up to the end of the stroke, while as regards the pneumatic cylinders 74 the movement of the rod 82 in retraction is determined, when the cam element 90 comes into contact with the rolling element 88 of the cam mechanism, by the profile 90a of the cam element 90, and is therefore controllable through the vertical displacement of the table 32 under control of the first actuating device 62. Such a configuration allows to obtain a driving unit which is robust, yet at the same time less complex and expensive than a solution using, for example, position-control linear actuators.

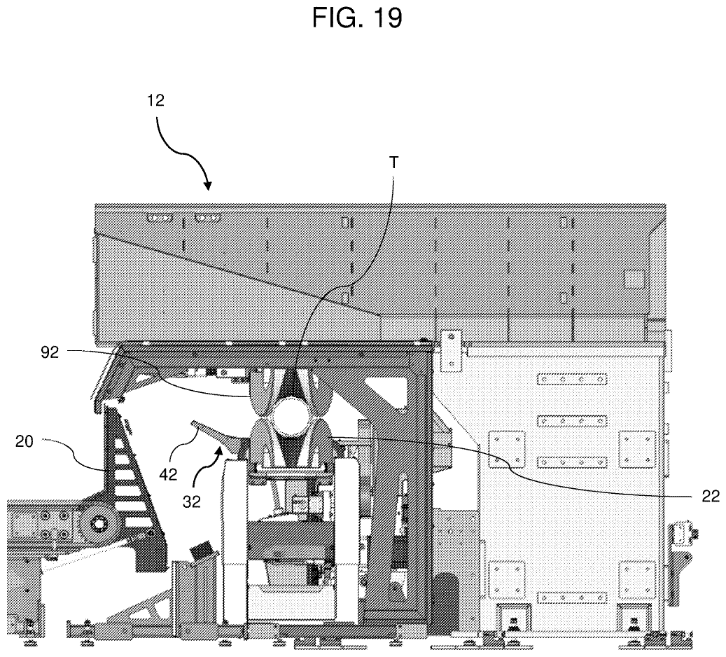

FIGS. 19 to 25 show the operation of the unloading system described above when the machine is used to work on a tube T with a circular cross-section.

FIG. 19 shows the tube T during the working process, supported from below by the tables 32 (not visible in FIG. 19) of the various supporting and unloading devices 18, as well as by the rotating support members 22 (only one of which is visible in FIG. 19). Furthermore, in the present case the machine is also provided with one or more rotating support members 92 (only one of which is visible in FIG. 19) arranged above the feed axis x to laterally restrain the tube T. The divider members 20 are at this stage in the raised position, so as to laterally separate the working area of the machine from the external environment.

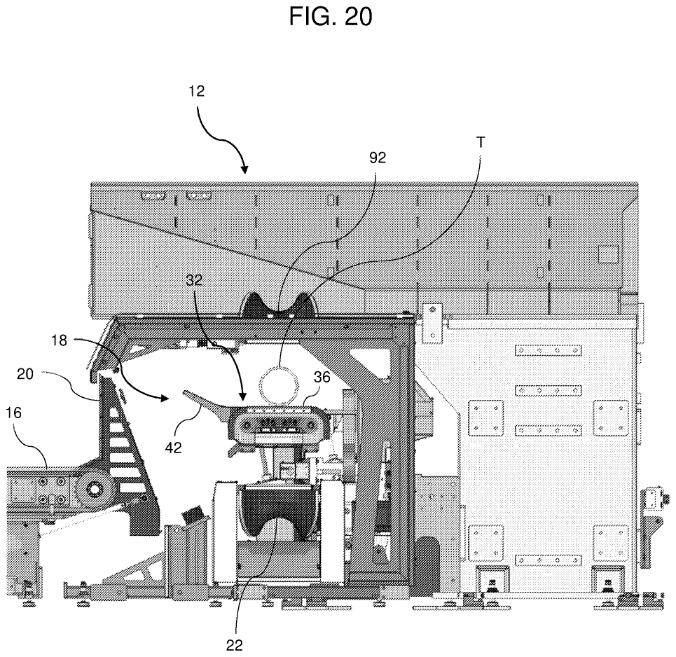

Once the tube T has been worked, the rotating support members 22 and 92 are moved away from the tube T by means of a downward movement of the lower rotating support member(s) 22 and upward movement of the upper rotating support member(s) 92, whereby the tube T remains supported on the tables 32 of the supporting and unloading devices 18 only, as shown in FIG. 20. The tables 32 are still in the working position and the divider members 20 are still in the raised position.

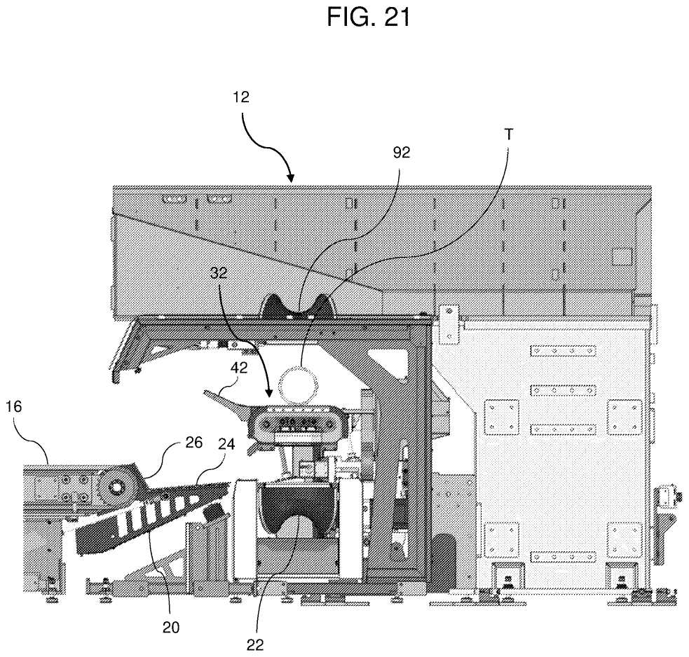

FIG. 21 shows a subsequent stage, in which the divider members 20 have been moved to the lowered position, while the table 32 of the supporting and unloading devices 18 are still in the working position.

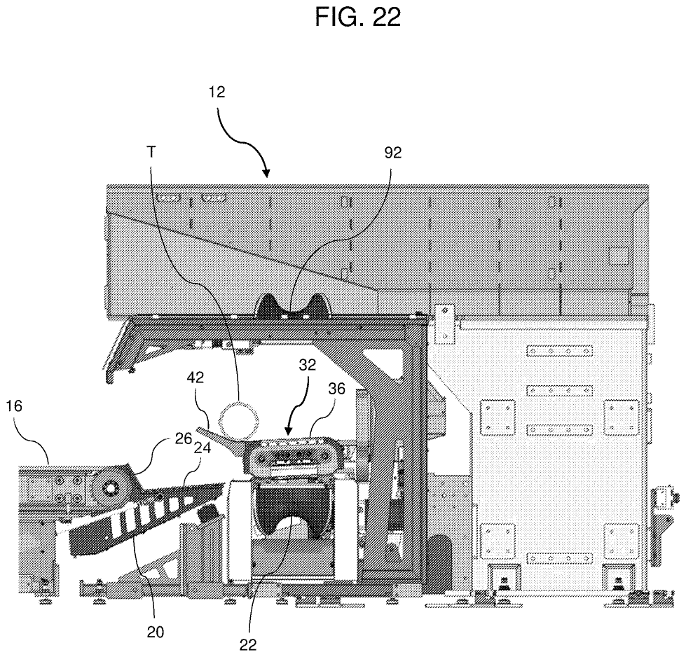

The tables 32 are then brought closer to the respective divider members 20, as shown in FIG. 22, by means of downward vertical translational movement of the second support structures 52 of the supporting and unloading devices 18. Furthermore, still with reference to FIG. 22, once the downward vertical translational movement of the second support structures 52 has been completed, the tables 32 are slightly tilted by actuation of the pneumatic cylinders 72 of the respective second actuating devices 70, each reaching a position corresponding to that shown in FIG. 16. As a result of the inclination of the tables 32, the tube T rolls along the upper surface 38 of the first table portion 36 until it stops at the joining surface 46.

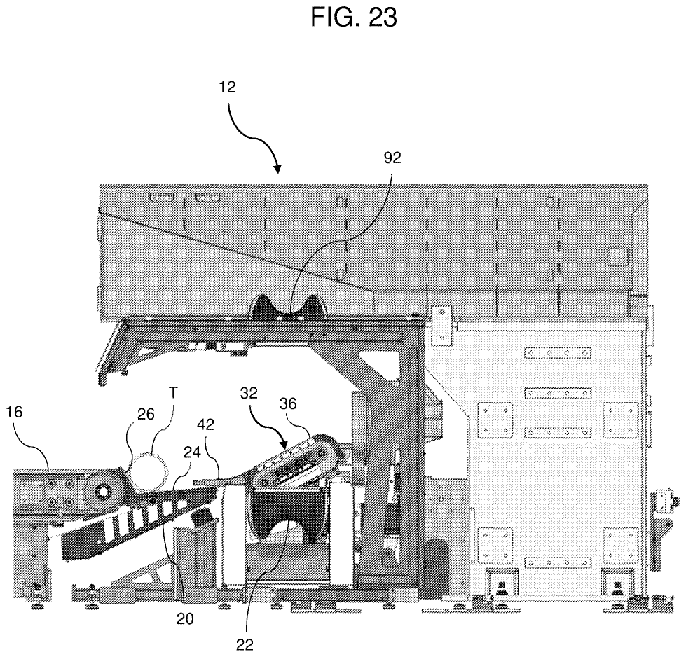

As shown in FIG. 23, the tables 32 are further rotated, by operation of the pneumatic cylinders 74 of the second actuating devices 70, until they reach an angular position corresponding to that of FIG. 17. In this way, the tube T is transferred from the tables 32 to the divider members 20 and then rolls along the first surface portions 24 of the divider members until coming to rest against the second surface portions 26 of the divider members. In the case of a circular tube T, it is not necessary to move the tables 32 to the position shown in FIG. 18, as the inclination of the upper surface 38 of the first table portion 36 and the inclination of the upper surface 44 of the second table portion 42 are sufficient to cause rolling of the tube T from the tables 32 to the divider members 20.

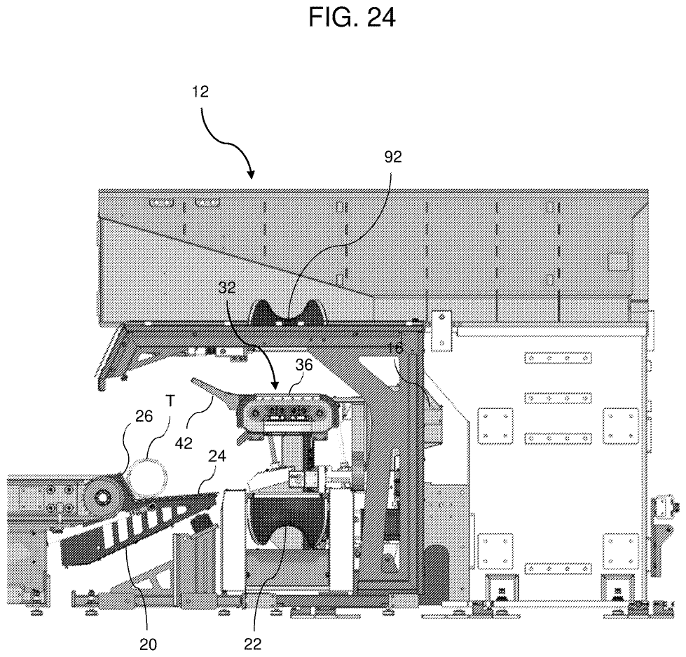

At this point, as shown in FIG. 24, the tables 32 of the supporting and unloading devices 18 are brought back to the working position.

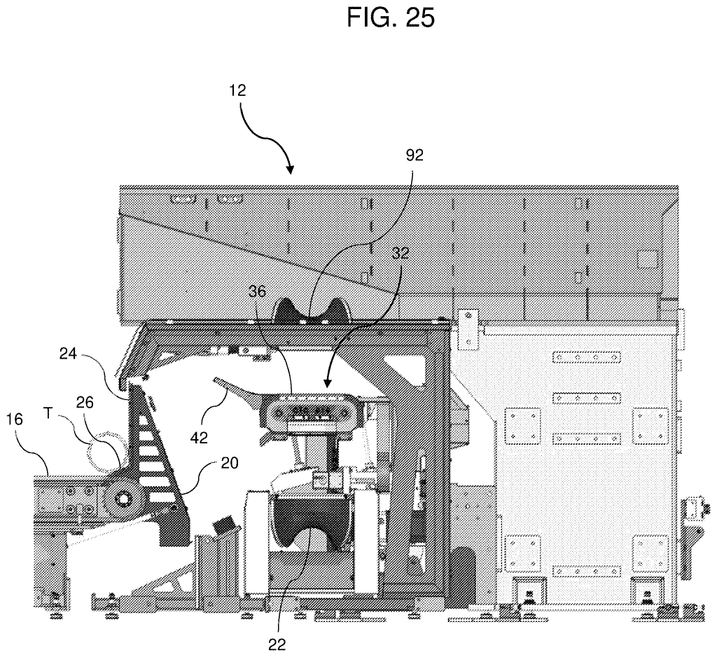

Finally, the divider members 20 are moved from the lowered position to the raised position, with the result that the tube T supported by them is transferred to the conveyor belts 16 (FIG. 25). The machine is thus ready to work a new tube.

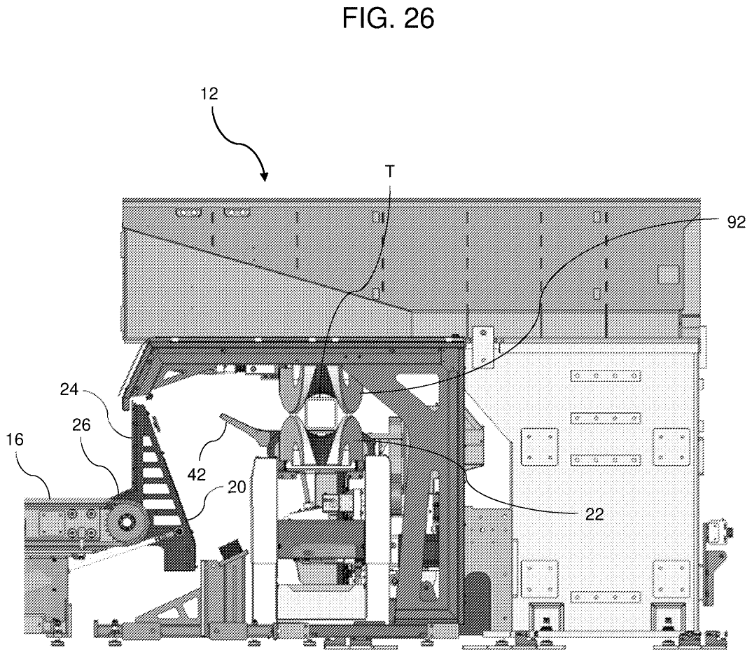

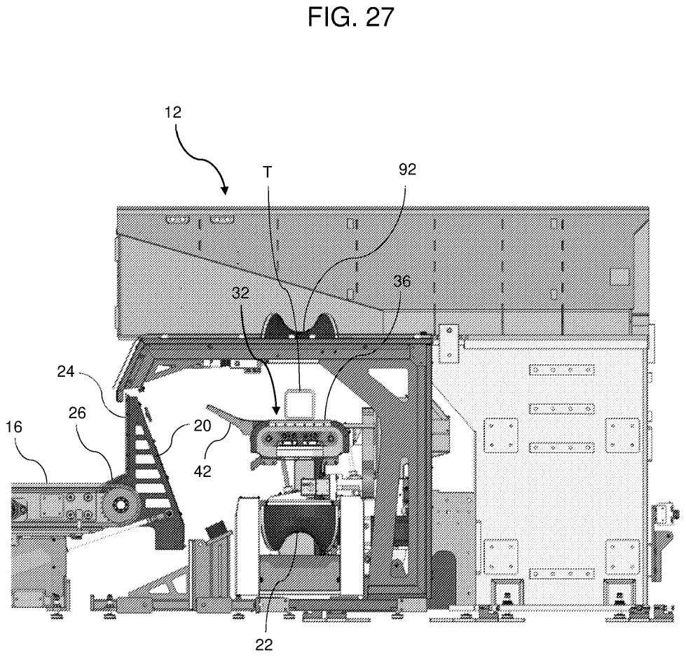

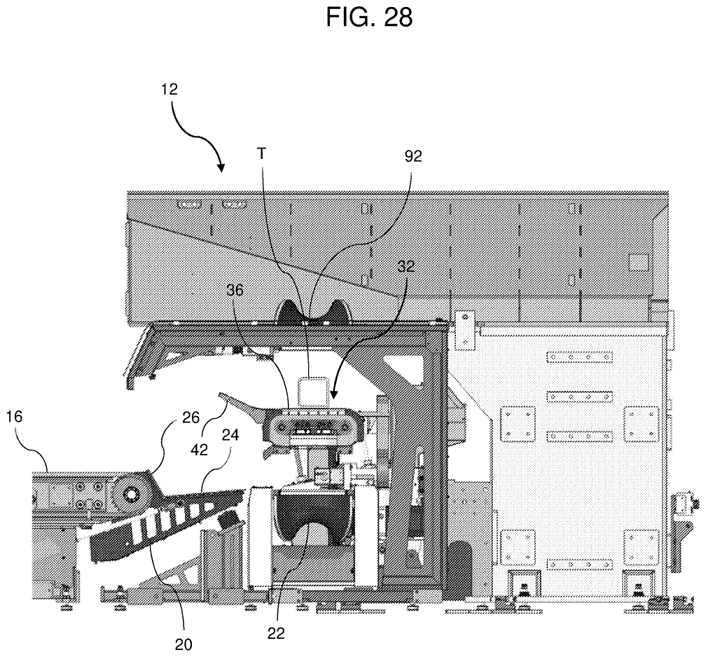

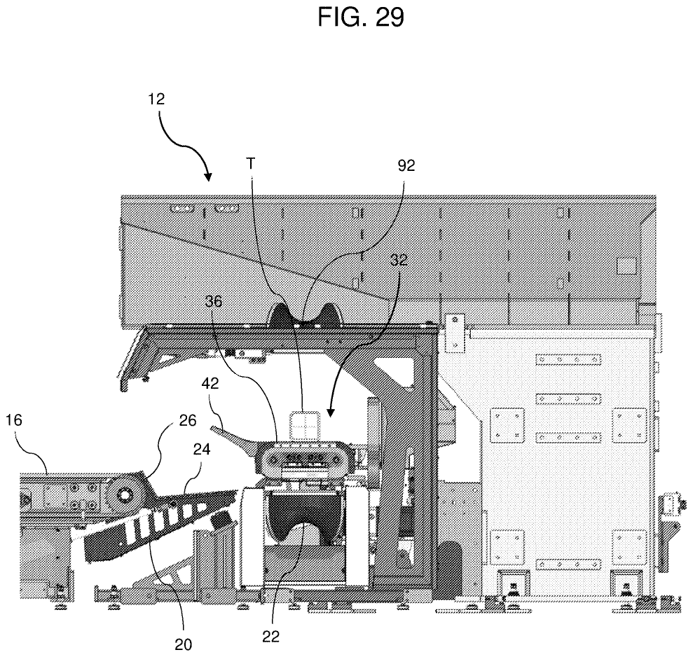

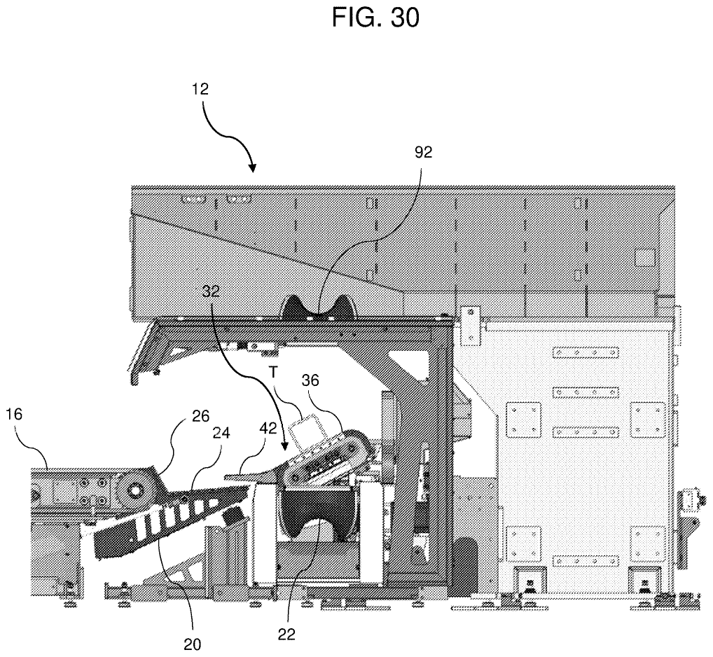

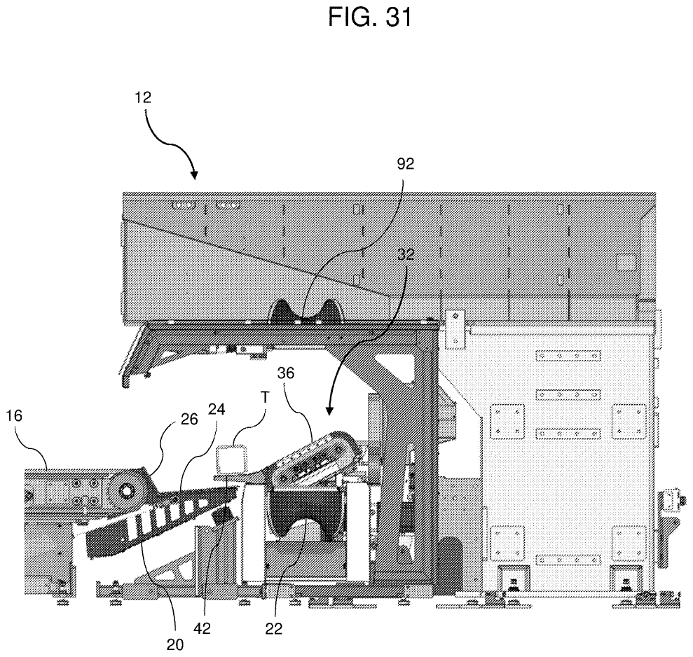

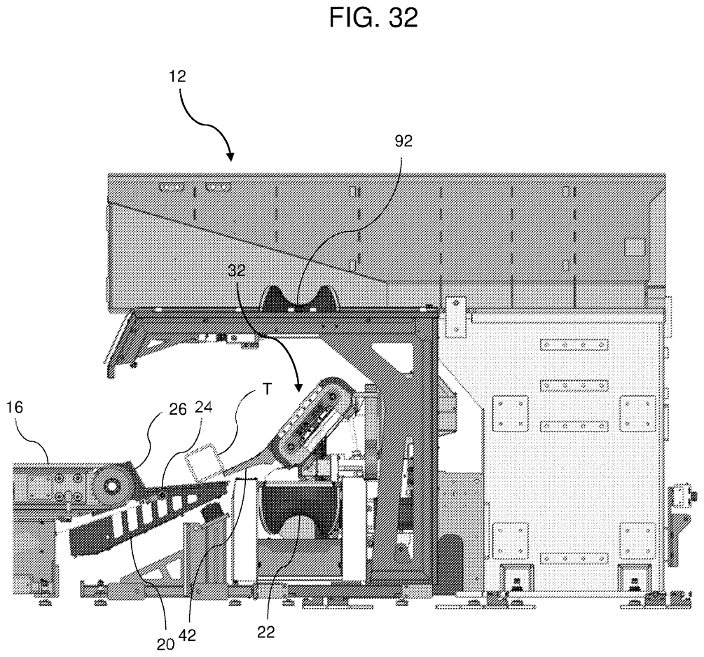

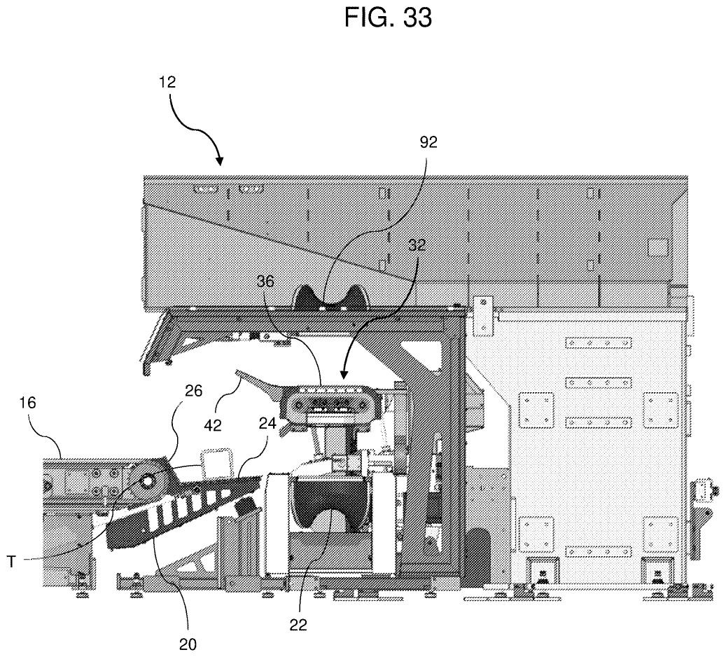

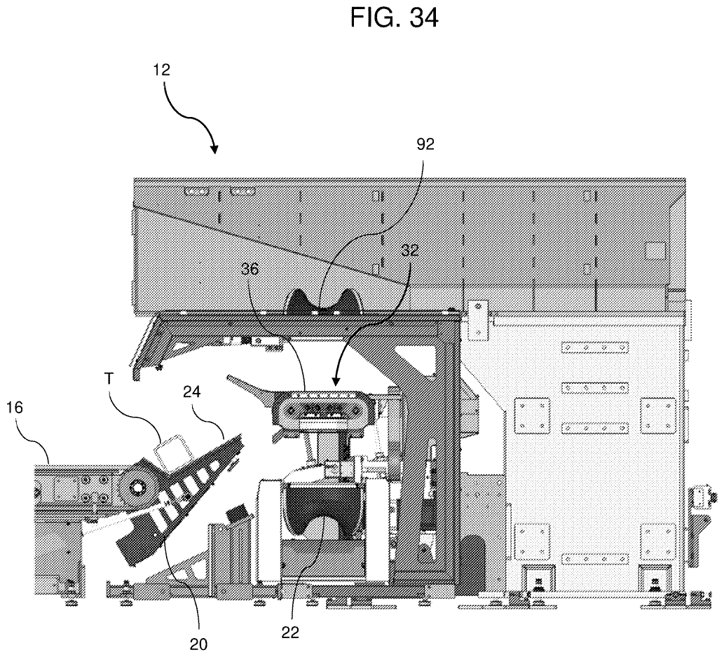

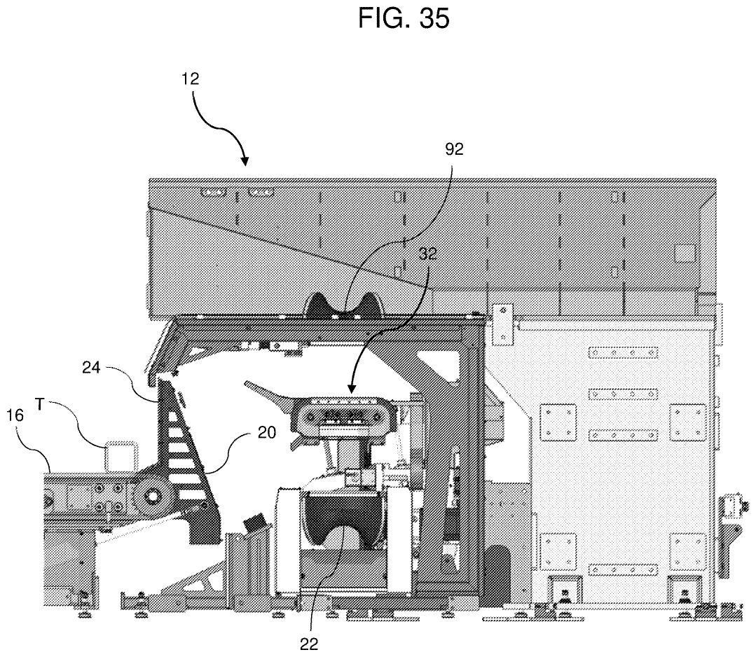

Finally, FIGS. 26 to 35 show the operation of the unloading system described above when the machine is used for the working of a tube T having a square cross-section. The sequence of movements of the divider members 20 and the tables 32 of the supporting and unloading devices 18 is similar to that described above with reference to FIGS. 19 to 25 and will therefore not be described in detail again. The only difference is that in this case the tables 32 are moved from the working position to the unloading position of FIG. 18, so as to allow the tube T to shift from the second table portion 42 of the tables 32 to the divider members 20 (FIGS. 31 and 32). In this case, therefore, after having reached the position of FIG. 17, the tables 32 are lifted and further rotated about the axis of rotation x2, according to a law of motion defined by the profile of the cam element 90 of the cam mechanism, until they reach the position of FIG. 18. The same applies to tubes of any other non-circular shape.

As is evident from the above description, an unloading system according to the present invention allows to control in an optimal way the tube unloading movement, even in the case of tubes and profiles with a non-circular cross-section.

The present invention has been described herein with reference to preferred embodiments thereof. It is to be understood that other embodiments may be envisaged, which share the same inventive core as those described herein, as defined by the following claims.

1-22. (canceled)

23. A machine for laser working of tubes and profiles, comprising
a working unit provided with a laser working head,
a feeding device arranged to move each time a tube or profile to be worked towards the working unit along a feed axis,
an unloading system for unloading the tube or profile at the end of the working process, said unloading system comprising one or more supporting and unloading devices arranged along the feed axis of the machine and below said axis, wherein each supporting and unloading device comprises a table and a driving unit associated with the table, and
a control unit,
wherein the table of each supporting and unloading device comprises a first table portion having an upper surface, and a second table portion extending laterally outwards relative to the first table portion and having an upper surface,
wherein said driving unit is configured to produce a roto-translational movement of the table of each supporting and unloading device, with a vertical translation and a rotation about a horizontal axis of rotation, oriented parallel to the feed axis of the machine, between a working position, in which the upper surface of the first table portion is oriented so as to support the tube or profile being worked, and in which the upper surface of the second table portion is oriented so that an outer longitudinal edge of said upper surface is placed at a height greater than that of an inner longitudinal edge of said upper surface, and an unloading position, in which the table is shifted vertically and rotated about said axis of rotation relative to said working position, in such a manner that an outer longitudinal edge of the upper surface of the first table portion is placed at a height lower than that of an inner longitudinal edge of said upper surface, and the outer longitudinal edge of the upper surface of the second table portion is placed at a height lower than or equal to that of the inner longitudinal edge of said upper surface, and
wherein said control unit is programmed to control the driving unit of each supporting and unloading device so as to move the table from said working position to said unloading position and vice versa.

24. The machine of claim 23, wherein the upper surface of the first table portion of the table of each supporting and unloading device is configured in such a manner that when the table is in said working position the outer longitudinal edge and the inner longitudinal edge of said upper surface are placed at substantially the same height.

25. The machine of claim 23, wherein the upper surface of the first table portion and the upper surface of the second table portion of the table of each supporting and unloading device are designed in such a manner that a plane passing through the outer longitudinal edge and the inner longitudinal edge of the upper surface of the second table portion is inclined by a given angle to a plane passing through the outer longitudinal edge and the inner longitudinal edge of the upper surface of the first table portion.

26. The machine of claim 23, wherein the upper surface of the first table portion of the table of each supporting and unloading device is a substantially flat surface.

27. The machine of claim 23, wherein the upper surface of the second table portion of the table of each supporting and unloading device is a substantially flat surface.

28. The machine of claim 26, wherein the table of each supporting and unloading device further has an arcuate joining surface joining the upper surface of the first table portion with the upper surface of the second table portion.

29. The machine of claim 23, wherein the first table portion of the table of each supporting and unloading device is provided with a plurality of idle rollers, arranged longitudinally spaced apart from each other and supported in a freely rotatable manner about respective axes of rotation oriented parallel to the plane of the upper surface of the first table portion and perpendicular to the feed axis of the machine.

30. The machine of claim 23, wherein the first table portion of the table of each supporting and unloading device is provided with anti-slipping means configured to allow the tube to slide without slipping along the first table portion when the table is rotated relative to said working position.

31. The machine of claim 30, wherein said anti-slipping means comprise roller chains mounted on freely rotatable sprockets arranged at one or both longitudinal ends of the first table portion.

32. The machine of claim 23, wherein said roto-translational movement of the table of each supporting and unloading device comprises, at least in a phase thereof, a vertical translational movement and a simultaneous rotary movement about said axis of rotation.

33. The machine of claim 23, wherein each supporting and unloading device comprises a first support structure, which supports the table in a rotatable manner about said axis of rotation, and a second support structure, on which said first support structure is mounted in a vertically movable manner, and wherein said driving unit comprises first actuating means for controlling the vertical translational movement of said first support structure relative to said second support structure, and second actuating means interposed between the table and said first support structure for controlling the rotation of the table relative to said first support structure about said axis of rotation.

34. The machine of claim 33, wherein said driving unit further comprises at least one cam mechanism interposed between the table and said first support structure and configured in such a manner that a law of motion of at least part of the rotary movement of the table about said axis of rotation is dependent on a law of motion of the vertical translational movement of said first support structure relative to said second support structure, at least starting from a given angle of rotation of the table about said axis of rotation relative to a horizontal direction.

35. The machine of claim 33, wherein said second actuating means comprise at least one first linear actuator and at least one second linear actuator, operating in series with respect to said first linear actuator, wherein said at least one first linear actuator is arranged to produce a first rotary movement of the table by a first angle about said axis of rotation, and wherein said at least one second linear actuator is arranged to produce a second rotary movement of the table by a second angle greater than said first angle about said axis of rotation.

36. The machine of claim 34, wherein said at least one cam mechanism is configured in such a manner that a law of motion of said second rotary movement of the table is dependent on the law of motion of the vertical translational movement of said first support structure relative to said second support structure at least from a given angle of rotation of the table about said axis of rotation relative to said horizontal direction.

37. The machine of claim 23, wherein said axis of rotation of the table is spaced apart from a centre of gravity of the first table portion along the feed axis of the machine, such that a rotation of the table in one direction or the other about said axis of rotation results in a downward or upward displacement of the centre of gravity of the first table portion.

38. The machine of claim 23, wherein the unloading system further comprises one or more divider members arranged along a direction parallel to the feed axis of the machine, wherein each divider member is rotatably supported for rotation about a horizontal axis of rotation so as to be movable between a lowered position, in which an operating surface of the divider member is facing substantially upwards to receive from the supporting and unloading device(s) the tube or profile that has been worked, and a raised position, in which said operating surface is facing away from the feed axis of the machine, so that, as a result of a displacement of the divider member from said lowered position to said raised position, the tube or profile received on the operating surface is moved towards the outside of the machine and, in said raised position, the divider member acts as a separating element separating a working area of the machine from an external environment.

39. The machine of claim 38, wherein said operating surface of each divider member comprises a first surface portion and a second surface portion, which is arranged adjacent to the first surface portion and is inclined to the first surface portion, wherein in said lowered position of the divider member the first surface portion is inclined to a horizontal direction so that a proximal longitudinal edge of said surface portion is at a height greater than that of a distal longitudinal edge of said surface portion to receive the tube or profile and cause the tube or profile to roll or slide until the tube or profile comes into abutment against the second surface portion, and wherein in said raised position of the divider member the first surface portion extends substantially vertically.

40. The machine of claim 37, wherein the first surface portion and the second surface portion of said operating surface are substantially flat surfaces forming with each other an angle greater than 90°.

41. The machine of claim 37, wherein the unloading system further comprises at least one pneumatic cylinder for controlling the displacement of each divider member between said lowered position and said raised position by rotation about the respective axis of rotation.

42. A method for laser working of tubes or profiles with a machine according to claim 23, comprising the steps of:
(a) performing one or more laser working operations on the tube or profile by means of said laser working head; and
(b) at the end of said step (a) of performing one or more laser working operations, unloading the tube or profile from the machine by displacement of the tables of one or more supporting and unloading devices from said working position to said unloading position, said displacement comprising both a vertical translational movement and a rotary movement about said axis of rotation.

43. The method of claim 42, wherein said rotary movement and said translational movement are performed at least in part simultaneously.
